(19) United States
(12) Patent Application Publication
(10) Pub. No.: US 2004/0148292 A1
(43) Pub. Date: Jul. 29, 2004

(54) Method of adaptive data transmission

(76) Inventor: Ian Kyle Clemens, Lansing, MI (US)

Correspondence Address: FOSTER, SWIFT, COLLINS & SMITH, P.C., 313 SOUTH WASHINGTON SQUARE, LANSING, MI, 48933, US

(21) Appl. No.: 10/352,317

(22) Filed: Jan. 27, 2003

(51) Int. Cl. G06F 17/00

(52) U.S. Cl. 707/100

(57) ABSTRACT

A method of adaptive transmission of data between a data transmission device and at least one data accessing device comprising, the steps of receiving a request from the data accessing device for data; determining a user environment of the data accessing device and transmitting the user environment back to the data transmission device, wherein the user environment comprises information corresponding to a data access and display software of the data accessing device, adapting a format and a level of functionality of the data to account for the user environment to produce adapted data, and transmitting the adapted data to the data accessing device. The user environment may also comprise information about a rendering engine and a platform.

### FIELD OF THE INVENTION

This invention relates to improved methods of data transmission, and, more particularly, to a method of adaptive data transmission particularly suitable for graphical data such as images and maps.

### BACKGROUND OF THE INVENTION

The development of computerized distribution information systems, such as the Internet, allows users to link with networks, and thus retrieve vast amounts of electronic information that was previously unavailable using conventional mediums. Such electronic information delivery increasingly is replacing the more conventional means of information delivery such as paper maps, newspapers, magazines and television, etc.

Users may be linked to the Internet through a protocol commonly referred to as the World Wide Web (WWW). With the World Wide Web, an entity having a domain name may create a web application, web page or page that can provide information and to a limited degree some interactivity. A computer user may “browse”, i.e., navigate around, the WWW by utilizing a suitable web browser, e.g., Netscape™, Internet Explorer™, and a network gateway, e.g., an Internet Service Provider (ISP). A web browser allows the user to specify or search for a web page on the WWW and subsequently retrieve and display web pages on the user's computer screen. Such web browsers are typically installed on personal computers or workstations to provide web client services, but increasingly may be found on wireless devices such as cell phones, personal data assistants, handhelds, etc.

The internet is based upon a suite of communication protocols known as Transmission Control Protocol/Internet Protocol (TCP/IP) which sends packets of data between a host machine, e.g., a data transmission device such as a server computer on the internet commonly referred to as a server or web server, and a data access device, commonly referred to as a client machine, e.g., a user's computer connected to the Internet. The WWW is an internet interface protocol which is supported by the same TCP/IP transmission protocol.

A single device may be both a data transmission device and/or a data accessing device depending on the circumstances. Examples of devices that are both include Instant/Text Messaging programs and filesharing programs which effectively network a series of computers together so that they both transmit and receive data. Data and information at a data transmission device can be delivered to a data access device and may typically comprise presentation components, e.g., navigational menus, pop-up windows/menus, maps, charts, graphs, visual images (static and dynamic), video and/or text. Static images, video and/or text may be specified in various languages or protocols such as Hyper-Text Mark-up Language (HTML), Extensible Hyper-Text Mark-up Language (XHTML), Dynamic Hyper-Text Mark-up Language (DHTML), JavaScript, Cascading Style Sheets (CSS), Scalable Vector Graphics (SVG), Flash, Vector Markup Language (VML), Document Object Model (DOM), Extensible Stylesheet Language (XSL), Extensible Mark-up Language (XML) and Synchronized Multimedia Integration Language (SMIL).

For example, maps and other graphics may be specified in a bitmap or raster file that is sent from a remote web server to the client. It can be sent, for example, in the language of an HTML file or, where it is desired to dynamically change the rendering of an HTML document, in the language of DHTML. (Client, web client or client machine or device is often used to refer to the software on a data accessing device that receives and processes web pages to render them perceivable by a human user of the system. For simplicity of nomenclature, for the present purpose, client, client machine or device will be used herein to interchangeably refer to the software and the human user of the system on which the client software is deployed.) The raster file may then be parsed by the web client in order to display the text and images on the display of the client machine. Examples of client-server map transmission using raster files include the on-line maps currently provided by www.mapquest.com or www.expediamaps.com.

Such client-server “architecture” dominates internet applications. One drawback to this type of architecture is that the client device or user environment is unknown to the server. That is, the data transmission device can send data to many data accessing devices, and each such accessing device may have a different operating system, web browser, processing speed, hardware, bandwidth and rendering engine, etc. A client can conceivably range from a powerful Macintosh PC to a lightweight Pocket PC personal digital assistant, or the latest, slimmed down cell phone. To best accommodate the myriad data access device environments web-based data transmission devices are typically programmed at a simplified and compromised level so that the data transmission applications work in a majority of client environments a majority of the time. This action saves development time for the server by reducing programming complexity and the risk of new technologies obsoleting or impairing the server's product/process. However, such action comes with a price. The latest technologies, more powerful functionality and more desirable end user features may not be compatible with the majority of client environments. Thus, data accessing devices that are capable of receiving such superior service are unable to do so.

This is particularly a problem with transmission of data corresponding to, for example, maps, where more and more features and functionality can be incorporated using vector graphics for clients with the capability to receive and handle such files. Vector graphics uses mathematical expressions such as coordinates to express geometric shapes. These shapes can then be assigned attributes such as fill color, stroke width, and opacity, etc.

Recently, a Scalable Vector Graphics (SVG) specification or standard has been promulgated for developers of software to use to present data in vector 2-D graphics format. See www.w3.org/TR/SVG. The SVG specification establishes a format and a level of functionality for two-dimensional vector graphics data, written in the XML computer language. Using this standard the rendering engine of the data access device can be categorized by its capability to receive and render vector graphics data.

Bitmap images, including gif, .jpg files, etc., in contrast to vector graphics, retain no information about underlying shapes and geometry. Instead, a bitmap image is made up of a fixed size two-dimensional matrix of pixels, with each pixel assigned a color. Bitmap images are easier for simpler machines to handle, and many older client machines do not have rendering engines capable of handling vector graphics formats like SVG.

It would be desirable to provide a data transmission method which would allow a data transmission device to optimize the data transmitted to a data access device based on the client's own user environment, instead of merely using default parameters of format and functionality set by a remote data transmission device or server.

### SUMMARY OF THE INVENTION

In accordance with a first aspect, a method of adaptive transmission of data between a data transmission device and at least one data access device comprises the steps of receiving a request from the data accessing device for data having a level functionality and a format, determining a user environment of the data accessing device and transmitting the user environment back to the data transmission device, wherein the user environment comprises information corresponding to data access and display software of the data accessing device, adapting the format and the level of functionality of the data to account for capability of the user environment to produce adapted data, and transmitting the adapted data to the data accessing device. In accordance with another aspect, the user environment comprises a capability of a rendering engine, and the data transmission device adapts the format and the level of functionality of the data to account for the capability of the rendering engine to render the adapted data.

From the foregoing disclosure and the following more detailed description of various preferred embodiments it will be apparent to those skilled in the art that the present invention provides a significant advance in the technology and art of web-mapping. Particularly significant in this regard is the potential the invention affords for providing a data accessing device with optimized high quality data from a data transmission device. Additional features and advantages of various preferred embodiments will be better understood in view of the detailed description provided below.

### BRIEF DESCRIPTION OF THE DRAWINGS

FIG. 1 is a schematic representation of an adaptive data transmission method in accordance with a preferred embodiment of the invention showing a data transmission device servicing multiple data accessing devices, where each data accessing device has varying platforms, browsers, operating systems and rendering engines.

FIG. 2 is a schematic representation of the steps of the method of determining the user environment in accordance with a preferred embodiment.

It should be understood that the appended drawings are not necessarily to scale, presenting a somewhat simplified representation of various preferred features illustrative of the basic principles of the invention. The specific design features of the method of adaptive data transmission, as disclosed here will be determined in part by the particular intended application and use environment. Certain features of the illustrated embodiments have been distorted relative to others to facilitate visualization and clear understanding. All references to direction and position, unless otherwise indicated, refer to the orientation illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the method of adaptive data transmission disclosed here. The following detailed discussion of various alternative and preferred features and embodiments will illustrate the general principles of the invention with reference to a method of adaptive data transmission suitable for use between a data transmission device and many data access devices over an internet connection. Other embodiments suitable for other applications will be readily apparent to those skilled in the art given the benefit of this disclosure.

With bitmap data (such as those used on known mapping services) a separate raster file needs to be retrieved from the server each time a client device requests a map with a different resolution. In contrast, vector graphics are scalable to different display resolutions. This is eliminates the need to continually go back to the server to access new files. In addition, printed output from a vector graphics file can use the full resolution of the printer and can be displayed at the same size on screens of different resolutions. The same vector graphic can be placed at different sizes on the same Web page, and re-used at different sizes on different pages. Vector graphics can be magnified to see fine detail, or to aid those with low vision.

Vector graphics such as Scalable Vector Graphics contain geometric objects such as lines and curves. This gives greater flexibility compared to raster-only formats (such as PNG and JPEG) which have to store information for every pixel of the graphic. Scalable Vector Graphics (SVG) can also integrate raster images and can combine them with vector information such as clipping paths to produce a complete illustration. Since all modern displays are raster-oriented, a key difference between raster-only and vector graphics is where the graphical data are rasterized. For vector graphics, the rasterization occurs at the data accessing device instead of being already rasterized on the data transmission device. SVG data is an attractive format for graphical data such as maps, process maps and flowcharts, floor diagrams and plans, downtown building footprints, etc. SVG data provides much greater levels of functionality that bitmap data, but not all clients can support SVG data.

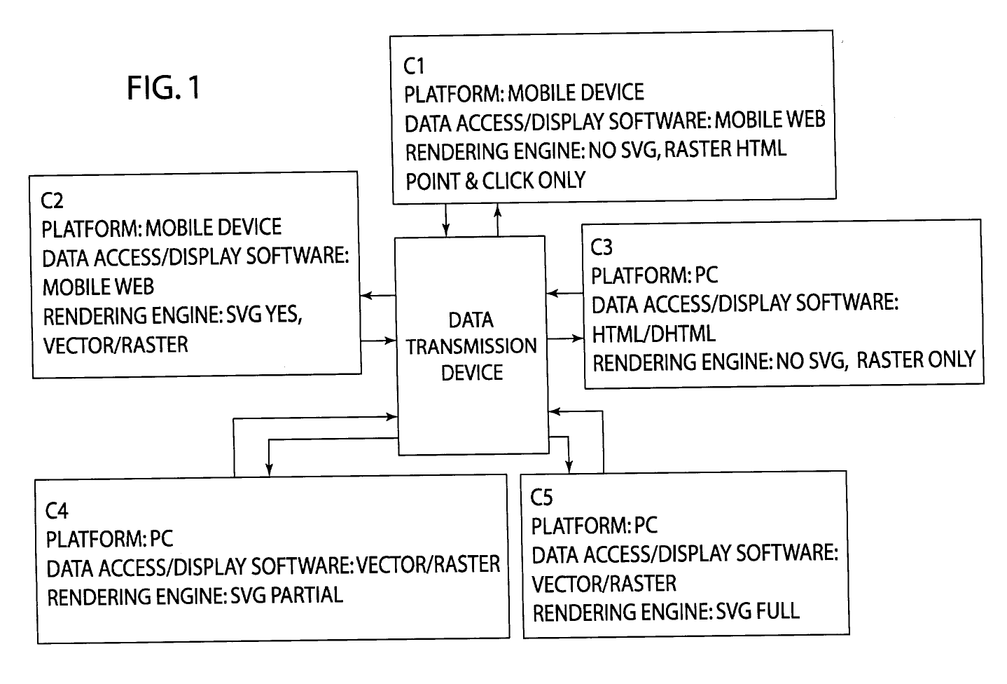

Referring now to the drawings, FIG. 1 shows a central data transmission device connected to a series of data access devices, C1-C5. Each data access device can have a platform; a data access and display software which can comprise, for example, a browser and operating system; and a rendering engine, with each comprising part of a user environment. Each data access device can have a different user environment. In accordance with a highly advantageous feature, the data transmission device can determine the user environment and adapt the data transmitted to be best suited for each particular user environment. Such adaptive data transmission is particularly valuable where the data to be transmitted can contain meaning for an end user at different levels of format and functionality, as is the case with maps and other graphical data.

Often a data transmission device is referred to as a server and a data accessing device as a client. It will be readily apparent to those skilled in the art, given the benefit of this disclosure, that a computer acting as a data transmission device can, in some instances, also act as a data access device, depending on whether the computer in question is accessing or transmitting the adapted data.

The platform of the user or client is generally categorized as either a personal computer (“pc” based platform), or a mobile computer which could be one of many different devices such as a personal digital assistant, cell phone, etc. The browser and operating system can vary, with each supporting a different level of data format and functionality. Preferably a check can be made on both the browser and operating system essentially simultaneously.

As used herein, the term format refers to one of a raster format, a vector format, and a mixed raster/vector format. Functionality can comprise one or more of a range of features comprising, for example, color gradients, which allow for a smooth and continuous transition along a vector from one color to another; graphic clipping or truncating of graphic elements; graphic filters, that is, a series of graphics operations that are applied to a given source graphic to produce a modified graphical result; scripting, use of a programming language; stroke or feature outline; interactivity such as user-initiated actions, hyperlinking, cursor properties, and zoom and pan; animation, the ability to change vector graphics over time; metadata, structured data about data; and basic shapes, including rectangles, circles, ellipses, lines, polylines and polygons, etc. Other features of functionality will be readily apparent to those skilled in the art given the benefit of this disclosure.

Each rendering engine has a capability to handle data. The rendering engine capability is based on its profile which can be, for example, a profile determined by the SVG standards, such as SVG Full, SVG Basic, and SVG Tiny. Each of these profiles has levels of functionality that are determined by the specification. The vendor of the rendering engine may choose not to include all of the functionality for a given profile. That is, the level of conformance With a particular SVG standard may vary. The rendering engine may be a separate plug-in module, such as, for example those found at www.adobe.com/SVG, or it may be incorporated into the browser.

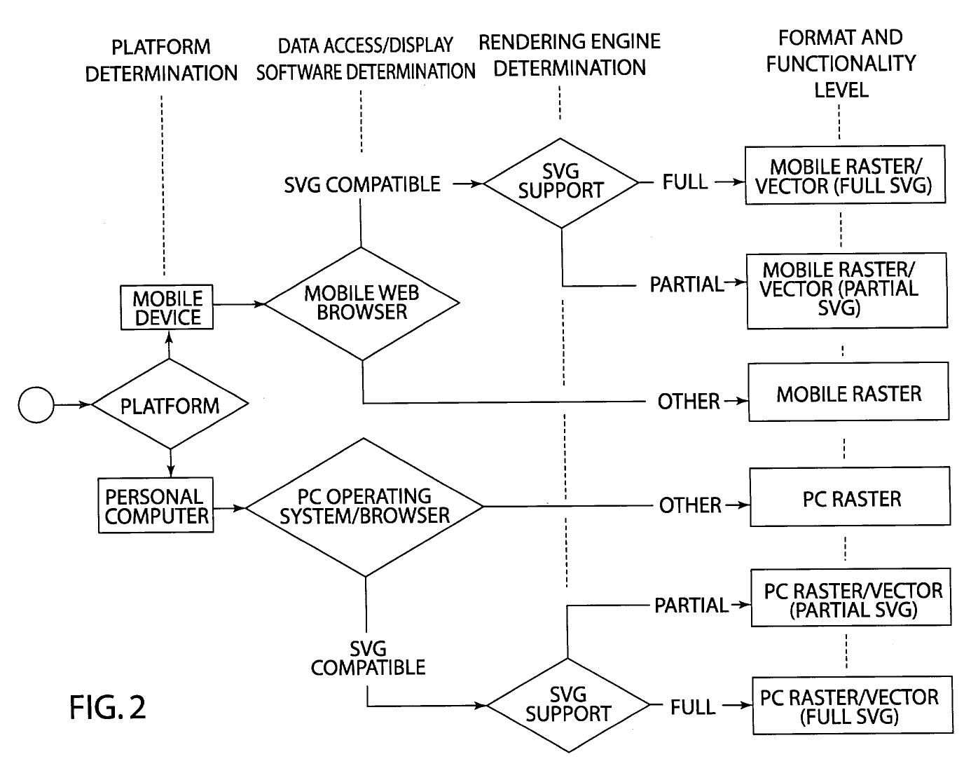

FIG. 2 shows a series of steps formed as a decision tree to determine information about the user environment. These steps are performed so the data transmission device can adapt the data to best suit the particular data access device. The platform information is determined (mobile device or personal computer) and the data access and display software are determined. For mobile devices this can comprise an SVG compatible browser/OS. If such a browser/OS is not present, the data transmission device converts the data to raster format for transmission. If such a browser is present, a check is made to determine the capability of SVG support of the rendering engine. Such capability can be SVG Full, as noted above, or it can be some capability less than SVG Full, generically referred to here as SVG partial. More specifically, SVG Partial could refer to a rendering engine with the capability of an SVG Full profile but with less than 100% conformance, and it can also refer to SVG Tiny with 100% conformance. A similar process can be used for pc platforms.

Since the rendering engine can be part of the browser, the steps of determining whether a browser is SVG compatible and determining the capability of the rendering engine may in some circumstances be conducted essentially simultaneously. Moreover, although FIG. 2 shows a determination of information corresponding to the platform, data access and display software and rendering engine, in some instances merely the browser and operating system or solely the rendering engine needs to be determined for the data transmission device to adapt the data for transmission to the data accessing device.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method of adaptive transmission of data between a data transmission device and at least one data accessing device, comprising in combination, the steps of:
receiving a request for data from the data accessing device;
determining a user environment of the data accessing device and transmitting the user environment back to the data transmission device,
wherein the user environment comprises information corresponding to a data access and display software of the data accessing device;
adapting a format and a level of functionality of the data to account for the user environment to produce adapted data; and
transmitting the adapted data to the data accessing device.

2. The method of adaptive transmission of claim 1 wherein the user environment further comprises information corresponding to a platform of the data accessing device.

3. The method of adaptive transmission of claim 2 wherein the platform is one of a mobile computer and a personal computer.

4. The method of adaptive transmission of claim 1 wherein the format of the data comprises one of a raster format, a vector format, and a mixed raster/vector format.

5. The method of adaptive data transmission of claim 4 wherein the vector format is produced pursuant to a Scalable Vector Graphics standard.

6. The method of adaptive data transmission of claim 1 wherein the level of functionality of the data comprises at least one of color gradients, graphic clipping, graphic filters, scripting, stroke, interactivity, animation, metadata and basic shapes.

7. The method of adaptive data transmission of claim 1 wherein the data is graphical data.

8. The method of adaptive data transmission of claim 1 wherein the data access and display software comprise an operating system and a web browser.

9. A method of adaptive transmission of data between a data transmission device and at least one data accessing device comprising, in combination, the steps of:
receiving a request for data from the data accessing device;
determining a user environment of the data accessing device and transmitting the user environment back to the data transmission device,
wherein the user environment comprises a capability of a rendering engine;
adapting a format and a level of functionality of the data to account for the user environment to produce adapted data; and
transmitting the adapted data to the data accessing device.

10. The method of adaptive transmission of claim 9 wherein the rendering engine is one of a plug-in and incorporated as a part of a browser, and is adapted to render scalable vector graphics.

11. The method of adaptive transmission of claim 9 wherein the user environment capability comprises a profile and a level of conformance.

12. The method of adaptive transmission of claim 11 wherein the profile is one of SVG Full, SVG Tiny, and SVG Basic.
